(19) United States
(12) Patent Application Publication
(10) Pub. No.: US 2021/0035725 A1
(43) Pub. Date: Feb. 4, 2021

(54) TRANSFORMER AND METHOD FOR MANUFACTURING THE SAME

(71) Applicant: Delta Electronics (Shanghai) Co.,Ltd., Shanghai (CN)

(72) Inventors: Jianping YING, Shanghai (CN); Liang WANG, Shanghai (CN); Qiang WANG, Shanghai (CN); Teng LIU, Shanghai (CN); Yong ZENG, Shanghai (CN); Jianxing DONG, Shanghai (CN)

(21) Appl. No.: 16/897,293

(22) Filed: Jun. 10, 2020

(30) Foreign Application Priority Data
Jul. 31, 2019 (CN) 201910698017.1

(51) Int. Cl. H01F 27/02; H01F 27/24; H01F 27/28; H01F 41/06; H01F 41/12

(52) U.S. Cl. CPC H01F 27/022; H01F 27/24; H01F 41/127; H01F 41/06; H01F 27/2823

(57) ABSTRACT

The invention relates to a transformer and a method for manufacturing the same. The transformer includes a magnetic core having a body part and a hollow part passing through the body part; a first winding wound around the body part of the magnetic core through the hollow part and including two first leads; a first infiltration material member enclosing the body part and the first winding through the hollow part, with the two first leads being exposed; a second winding wound around the first infiltration material member through the hollow part, isolated from the first winding, and including two second leads; a shell including an accommodating space, in which the magnetic core, the first winding, the first infiltration material, and the second winding are accommodated; and a pouring sealant poured into the accommodating space and maintaining the first leads and the second leads to be exposed outside the shell.

### CROSS-REFERENCE TO RELATED APPLICATIONS

This non-provisional application claims priority under 35 U.S.C. § 119(a) on Patent Application No. 201910698017.1 filed in P. R. China on Jul. 31, 2019, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the present invention described herein. All references listed, cited and/or discussed in this specification are incorporated herein by reference in their entireties and to the same extent as if each reference was individually incorporated by reference.

### FIELD OF THE INVENTION

The present invention relates to a transformer, and particularly to a miniaturized transformer with high insulating property and a method for manufacturing the same.

### BACKGROUND OF THE INVENTION

Recently, the transformer is widely applied in medium-voltage power distribution apparatus, such as transformers for drive, protection, or power of IGBT, or the like. Various systems have a large demand for transformers in modular design. In order to improve power density of the application system, the volume of the transformer is required to be miniaturized.

In a low-voltage system, air is generally used as an insulating medium for the insulation in the transformer. The volume of the product is generally acceptable since there is low requirement for insulation. However, in a medium-voltage system, there are high requirements for withstand voltage and partial discharge (PD) of the insulation in the transformer. In the traditional medium-voltage transformer, bobbin is typically used to isolate the high and low voltage windings while air serves as the insulating medium. The resulted transformer is thus large in volume, but low in insulation level, which cannot satisfy the requirements for system performance and power density.

Alternatively, in the traditional medium-voltage transformer, a molded, prefabricated isolation structure may be used to isolate the high and low voltage windings with each other. Then, holes are formed in the prefabricated isolation structure, through which pouring sealant enters inside when the pouring sealant is poured, e.g. in a negative pressure, into the shell. However, the holes in the prefabricated isolation structure may impede flowing of the pouring sealant, which does not facilitate expelling bubbles inside the mould cavity but easily produces defects inside, so that the application in a relatively high voltage is limited.

Therefore, an urgent problem in the art is to develop a transformer with high insulating performance and small volume as well as a method for manufacturing the same, solving the problems in the prior art.

### SUMMARY OF THE INVENTION

An object of the invention is to provide a transformer and a method for manufacturing the same. By disposing an infiltration material member between the windings, the levels of the withstand voltage and the partial discharge can be improved, so that the transformer is reduced in volume and enhanced in competitiveness, achieving objects of simplifying manufacturing process and decreasing production cost.

Another object of the invention is to provide a transformer and a method for manufacturing the same. The transformer includes a first winding, a magnetic core, a first infiltration material member, a second winding, a pouring sealant, and a shell. Although voltage stress is concentrated between the first and second windings serving respectively as high and low voltage windings of the transformer, a reliable isolation structure is realized by providing the infiltration material member, so that high insulating property and miniaturization of the transformer can be achieved. The infiltration material member is poured with the pouring sealant, e.g. in a negative pressure. The pouring sealant can fully enter into inside of the infiltration material member, fill clearances in the infiltration material member, and form an insulating isolation structure after being cured. Since process of pouring the pouring sealant is performed in a negative pressure, it is ensured that no defect, such as crack, bubble, or the like, exists inside the insulating isolation structure and the pouring sealant, so that a withstand voltage and a partial discharge extinction voltage of the transformer can be significantly improved, a volume of the transformer can be reduced, and the cost can be decreased.

To achieve at least one of the above objects, the invention provides a transformer, which comprises a magnetic core, at least one first winding, a first infiltration material member, at least one second winding, a shell, and a pouring sealant. The magnetic core has a body part and a hollow part passing through the body part. The at least one first winding is wound around the body part of the magnetic core through the hollow part, wherein the at least one first winding comprises at least two first leads. The first infiltration material member encloses the body part of the magnetic core and the at least one first winding through the hollow part, with the at least two first leads of the at least one first winding being exposed. The at least one second winding is wound around the first infiltration material member through the hollow part, and isolated from the at least one first winding, wherein the at least one second winding comprises at least two second leads. The shell comprises an accommodating space, in which the magnetic core, the at least one first winding, the first infiltration material member, and the at least one second winding are accommodated, with the at least two first leads and the at least two second leads being partially exposed outside the shell. The pouring sealant is poured into the accommodating space, covers the magnetic core, the at least one first winding, the first infiltration material, and the at least one second winding, and maintains the at least two first leads and the at least two second leads being partially exposed outside the shell.

In one embodiment, the body part is of a ring or racetrack shape and has a rectangular cross section with at least one chamfer part.

In one embodiment, the body part is of a ring or racetrack shape and has a circular cross section.

In one embodiment, the transformer further comprises a second infiltration material member enclosing the body part of the magnetic core through the hollow part, and separating the at least one first winding from the magnetic core.

In one embodiment, the first infiltration material member is formed of glass fiber, non-woven fabric, or paper. The second infiltration material member is formed of glass fiber, non-woven fabric, or paper. The pouring sealant is formed of epoxy resin.

In one embodiment, both the at least one first winding and the at least one second winding are configured in a sparse winding distribution through the hollow part.

In one embodiment, one of the at least one first winding and the at least one second winding is configured in a close winding distribution, while the other of the at least one first winding and the at least one second winding is configured in a sparse winding distribution through the hollow part. Or, the at least one first winding and the at least one second winding are both configured in a close winding distribution through the hollow part.

In one embodiment, at least one of the at least one first winding and the at least one second winding is configured in a parallel winding distribution through the hollow part.

In one embodiment, each of the at least one first winding and the at least one second winding comprises at least two winding units.

In one embodiment, the transformer further comprises a first sleeve sheathed onto the at least two first leads and a second sleeve sheathed onto the at least two second leads.

In one embodiment, the shell comprises at least two first guide pins and at least two second guide pins, which are disposed on an upper edge of the shell and exposed outside the accommodating space. Ends of the at least two first leads are connected to the at least two first guide pins, respectively. Ends of the at least two second leads are connected to the at least two second guide pins, respectively.

To achieve the at least one of the above objects, the invention further provides a method for manufacturing a transformer. Said method comprises the steps of: (a) providing a magnetic core having a body part and a hollow part passing through the body part; (b) winding at least one first winding onto the body part of the magnetic core through the hollow part, wherein the at least one first winding comprises at least two first leads; (c) enclosing the body part of the magnetic core and the at least one first winding with a first infiltration material member through the hollow part, with the at least two first leads of the at least one first winding being exposed; (d) winding at least one second winding around the first infiltration material member through the hollow part and isolating the at least one second winding from the at least one first winding, wherein the at least one second winding comprises at least two second leads; (e) providing a shell comprising an accommodating space, in which the magnetic core, the at least one first winding, the first infiltration material member, and the at least one second winding are accommodated, with the at least two first leads and the at least two second leads being partially exposed outside the shell; and (f) pouring a pouring sealant into the accommodating space to cover the magnetic core, the at least one first winding, the first infiltration material member, and the at least one second winding and maintain the at least two first leads and the at least two second leads to be partially outside the shell.

In one embodiment, the step (a) further comprises the step of (a1) enclosing the body part of the magnetic core with a second infiltration material member through the hollow part.

In one embodiment, the first infiltration material member is formed of glass fiber, non-woven fabric, or paper. The second infiltration material member is formed of glass fiber, non-woven fabric, or paper. The pouring sealant is formed of epoxy resin.

In one embodiment, the step (f) is to pour the pouring sealant in a negative pressure.

In one embodiment, the body part is of a ring or racetrack shape, and has a rectangular cross section with at least one chamfer part.

In one embodiment, the body part is of a ring or racetrack shape, and has a circular cross section.

In one embodiment, both the at least one first winding and the at least one second winding are configured in a sparse winding distribution through the hollow part.

In one embodiment, one of the at least one first winding and the at least one second winding is configured in a close winding distribution, while the other of the at least one first winding and the at least one second winding is configured in a sparse winding distribution through the hollow part. Or, the at least one first winding and the at least one second winding are both configured in a close winding distribution through the hollow part.

In one embodiment, at least one of the at least one first winding and the at least one second winding is configured in a parallel winding distribution through the hollow part.

### BRIEF DESCRIPTION OF THE DRAWINGS

Reference will now be made in detail to embodiments of the present invention, examples of which are illustrated in the accompanying drawings, in which:

FIG. 1 is a cross-sectional view showing structure of a transformer in a first embodiment of the invention.

FIG. 2 is a diagram illustrating a method for manufacturing the transformer in the first embodiment of the invention.

FIGS. 3A-3E are schematic views showing structures of the transformer in the first embodiment of the invention in respective stages during manufacturing process.

FIGS. 4A-4D are views showing structure of the transformer in a second embodiment of the invention in stages of manufacture.

FIG. 5 is a cross-sectional view showing structure of the transformer in the second embodiment of the invention.

FIG. 6 is a cross-sectional view showing structure of the transformer in a third embodiment of the invention.

FIG. 7A shows a first example of a magnetic core in the transformer according to the invention.

FIG. 7B is a cross-sectional view of FIG. 7A.

FIG. 8A shows a second example of the magnetic core in the transformer according to the invention.

FIG. 8B is a cross-sectional view of FIG. 8A.

FIG. 9A shows a first example of the first winding wound around the magnetic core in the transformer according to the invention.

FIG. 9B is a top view of FIG. 9A.

FIG. 10 shows a second example of the first winding wound around the magnetic core in the transformer according to the invention.

FIG. 11 shows a third example of the first winding wound around the magnetic core in the transformer according to the invention.

FIG. 12 is a schematic view showing the arrangement of the infiltration material member in the transformer according to the invention.

### DETAILED DESCRIPTION OF THE INVENTION

The invention will now be described in details through following illustrative embodiments. However, it should be understood that an element, a structure or a feature in an embodiment can be beneficially incorporated into other embodiments without further recitation.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the present invention described herein. All references listed, cited and/or discussed in this specification are incorporated herein by reference in their entireties and to the same extent as if each reference was individually incorporated by reference.

It should also be understood that “comprises/comprising” when used in the specification is taken to specify the presence of stated features, integers, steps or components but dose not preclude the presence or addition of one or more other features, integers, steps or components or groups thereof.

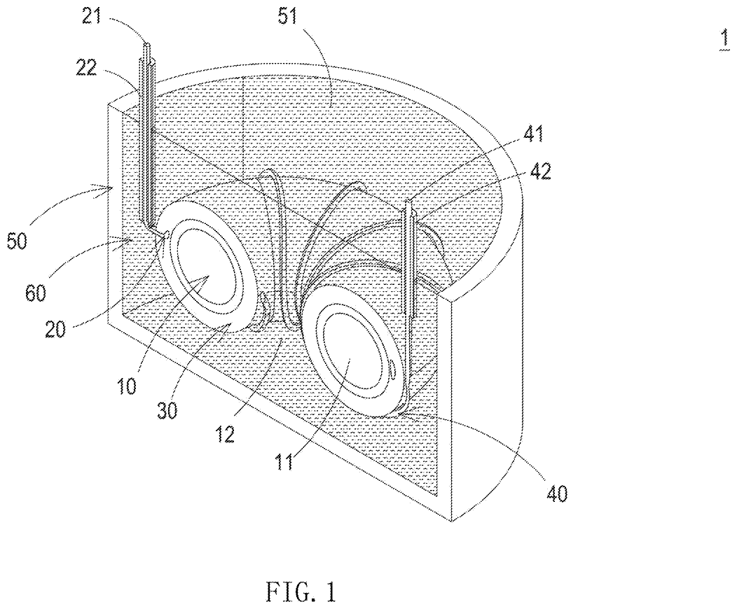

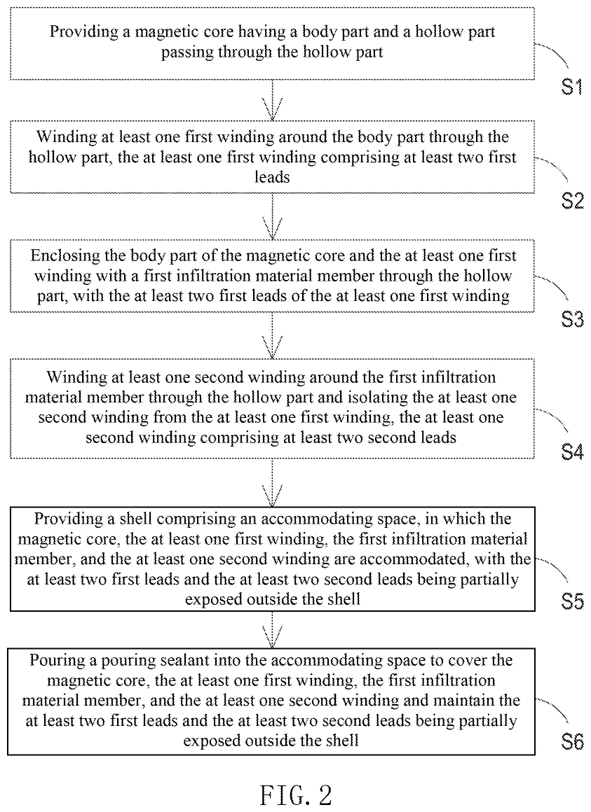

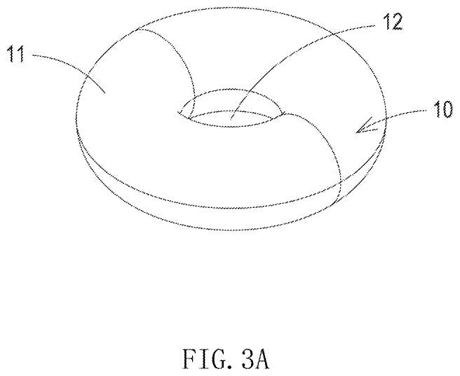

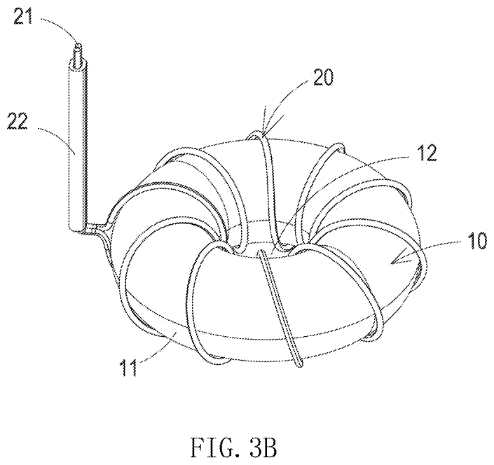

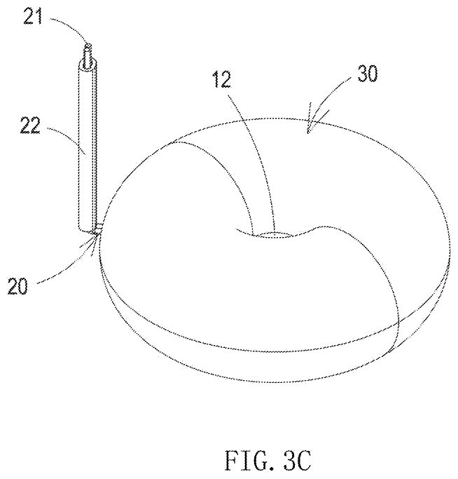

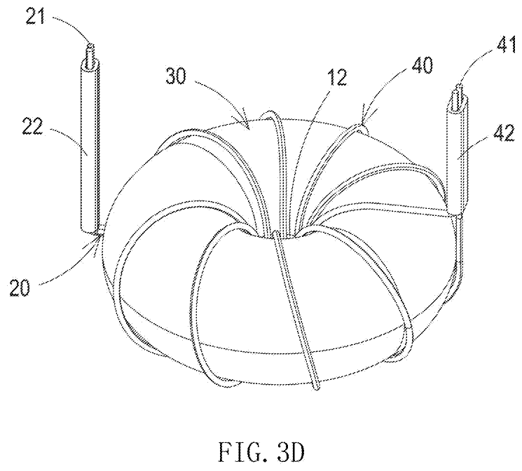

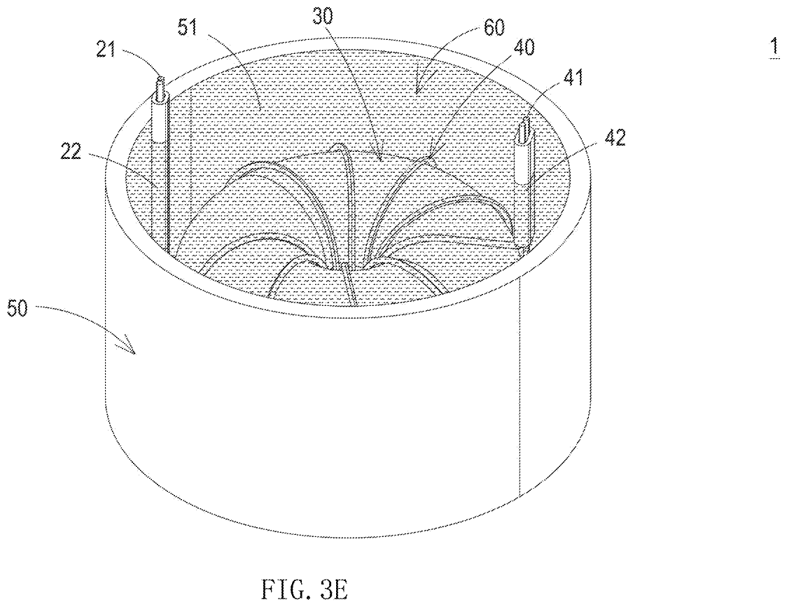

FIG. 1 is a cross-sectional view showing structure of a transformer in a first embodiment of the invention. FIG. 2 is a diagram illustrating the method for manufacturing the transformer in the first embodiment of the invention. FIGS. 3A-3E are schematic views showing structures of the transformer in the first embodiment of the invention in respective stages during manufacturing process.

In this embodiment, the transformer 1 comprises a magnetic core 10, at least one first winding 20, a first infiltration material member 30, at least one second winding 40, a shell 50, and a pouring sealant 60. The magnetic core 10 is for example a ring, which has a body part 11 and a hollow part 12 passing through the body part 11. The at least one first winding 20 is wound around the body part 11 of the magnetic core 10 through the hollow part 12 of the magnetic core 10. In this embodiment, the at least one first winding 20 may but not limited to be wound as e.g. a single wire around the body part 11 of the magnetic core 10 through the hollow part 12, and comprises at least two first leads 21. In this embodiment, a first sleeve 22, such as a heat-shrinkable sleeve, is sheathed on the at least two first leads 21, which facilitates increase of the creepage distance of the leads 21 and improvement of insulating property of the leads 21. In this embodiment, the first sleeve 22 has two channels isolated from each other, each channel being passed through by the corresponding lead. In other embodiment, each of the leads is sheathed outside with corresponding heat-shrinkable sleeve.

The first infiltration material member 30 encloses the body part 11 of the magnetic core 10 and the at least one first winding 20 through the hollow part 12 of the magnetic core 10, with the at least two first leads 21 of the at least one first winding 20 and the first sleeve 22 being exposed. The first infiltration material member 30 can be formed of glass fiber, non-woven fabric, or paper, although the invention is not limited thereto. The at least one second winding 40 is wound around the first infiltration material member 30 through the hollow part 12 of the magnetic core 10, and isolated from the at least one first winding 20. In this embodiment, the at least one second winding 40 is wound onto the first infiltration material member 30 through the hollow part 12 in the form of, for example, but not limited to, a single wire. The at least one second winding 40 comprises at least two second leads 41, and a second sleeve 42, e.g. a heat-shrinkable sleeve, sheathed around the at least two second leads 41, which facilitates increase of a creepage distance and improvement of insulating property of the second leads 41. In this embodiment, the second sleeve 42 has two channels isolated from each other, each channel being passed through by the corresponding leads. In other embodiment, each of the leads is sheathed outside with a corresponding heat-shrinkable sleeve outside. The first sleeve 22 and the second sleeve 42 may be spatially opposite to each other, although the invention is not limited thereto. In this embodiment, the at least one first winding 20 and the at least one second winding 40 can be three-layered insulating wires or varnished wires, although the invention is not limited thereto.

In this embodiment, the shell 50 comprises an accommodating space 51, in which the magnetic core 10, the at least one first winding 20, the first infiltration material member 30, and the at least one second winding 40 are accommodated. The at least two first leads 21, the first sleeve 22, the at least two second leads 41, and the second sleeve 42 are partially exposed outside the shell 50. In addition, the pouring sealant 60 is poured into the accommodating space 51 in a negative pressure, covering the magnetic core 10, the at least one first winding 20, the first infiltration material member 30 and the at least one second winding 40, and maintaining the at least two first leads 21, the first sleeve 22, the at least two second leads 41, and the second sleeve 42 being partially exposed outside the shell 50. The pouring sealant 60 is formed of epoxy resin, silicone rubber, or the like, although the invention is not limited thereto. In the negative pressure state, the pouring sealant 60 fully enters into inside of the first infiltration material member 30, filling clearances in the first infiltration material member 30, so as to form an insulating isolation structure after being cured. Such process ensures that there is no defect such as crack and/or bubble inside the insulating isolation structure, so that the withstand voltage and the partial discharge extinction voltage of the transformer 1 can be significantly improved, while the volume of the transformer 1 can be reduced.

The invention further discloses a method for manufacturing the transformer 1 as described above.

Please refer to FIGS. 1, 2 and 3A-3E again. Firstly, in step S1, a magnetic core 10 is provided. The magnetic core 10 can be, for example, but not limited to a ring, and has a body part 11 and a hollow part 12 passing through the body part 11, as shown in FIG. 3A.

Then, in step S2, at least one first winding 20 is wound around the body part 11 of the magnetic core 10 through the hollow part 12 of the magnetic core 10. The at least one first winding 20 is wound around the body part 11 of the magnetic core 10 through the hollow part 12 in the form of, for example, but not limited to a single wire. The at least one first winding 20 comprises at least two first leads 21, and a first sleeve 22, such as, a heat-shrinkable sleeve, sheathed onto the at least two first leads 21, as shown in FIG. 3B.

Then, in step S3, a first infiltration material member 30 encloses the body part 11 of the magnetic core 10 and the at least one first winding 20 through the hollow part 12 of the magnetic core 10, with the at least two first leads 21 and the first sleeve 22 of the at least one first winding 20 being exposed, as shown in FIG. 3C.

In step S4, at least one second winding 40 is wound around the first infiltration material member 30 through the hollow part 12 of the magnetic core 10, and isolated from the at least one first winding 20. The at least one second winding 40 is wound around the first infiltration material member 30 through the hollow part 12 in the form of, for example, but not limited to a single wire. The at least one second winding 40 comprises at least two second leads 41, and a second sleeve 42, e.g. a heat-shrinkable sleeve, sheathed onto the at least two second leads 41, as shown in FIG. 3D. Althrough in this embodiment, the first sleeve 22 and the second sleeve 42 may be spatially opposite to each other, the invention is not limited thereto.

Further, in step S5, a shell 50 is provided, which comprises an accommodating space 51, in which the magnetic core 10, the at least one first winding 20, the first infiltration material member 30, and the at least one second winding 40 are accommodated, with the at least two first leads 21, the first sleeve 22, the at least two second leads 41, and the second sleeve 42 being partially exposed outside the shell 50.

Finally, in step S6, a pouring sealant 60 is poured into the accommodating space 51 in a negative pressure, covering the magnetic core 10, the at least one first winding 20, the first infiltration material member 30, and the at least one second winding 40, and maintaining the at least two first leads 21, the first sleeve 22, the at least two second leads 41 and the second sleeve 42 being partially exposed outside the shell 50 and partially covered by the pouring sealant 60, as shown in FIG. 3E. The obtained transformer 1 is shown in FIG. 1.

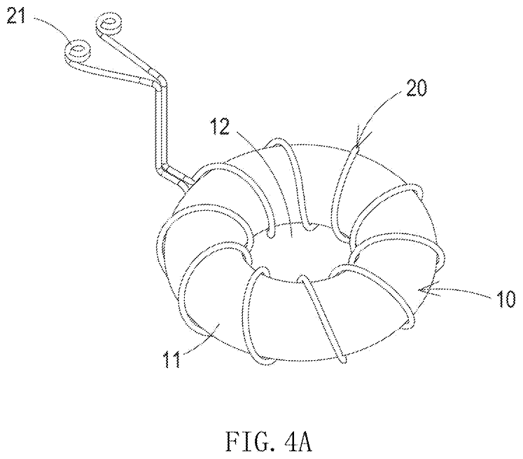

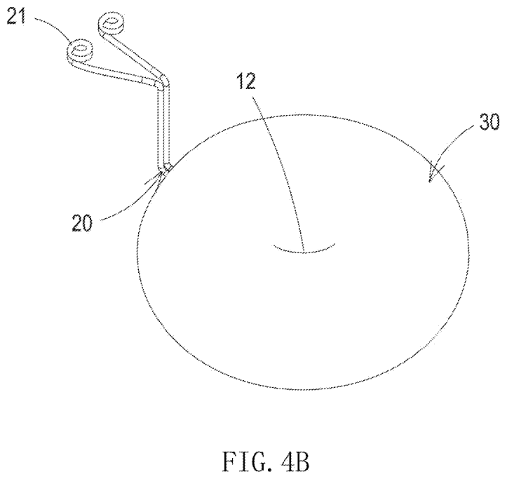

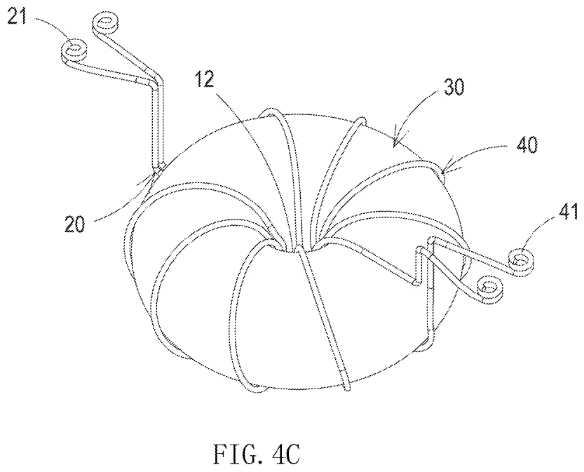

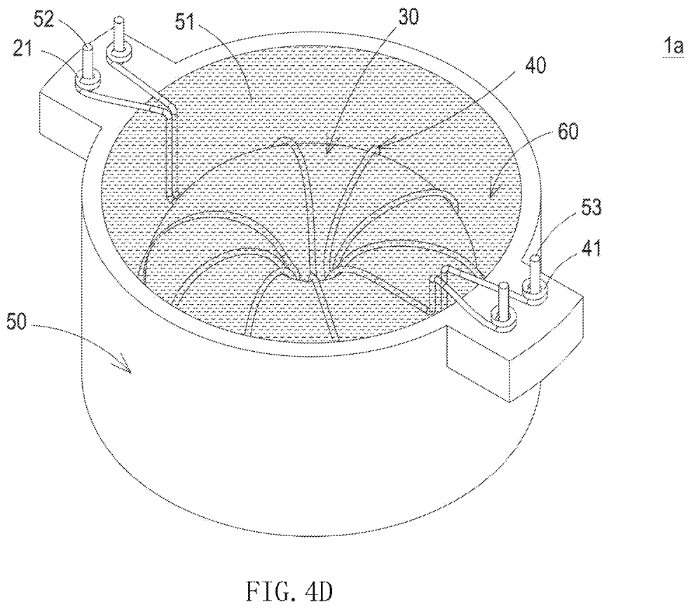

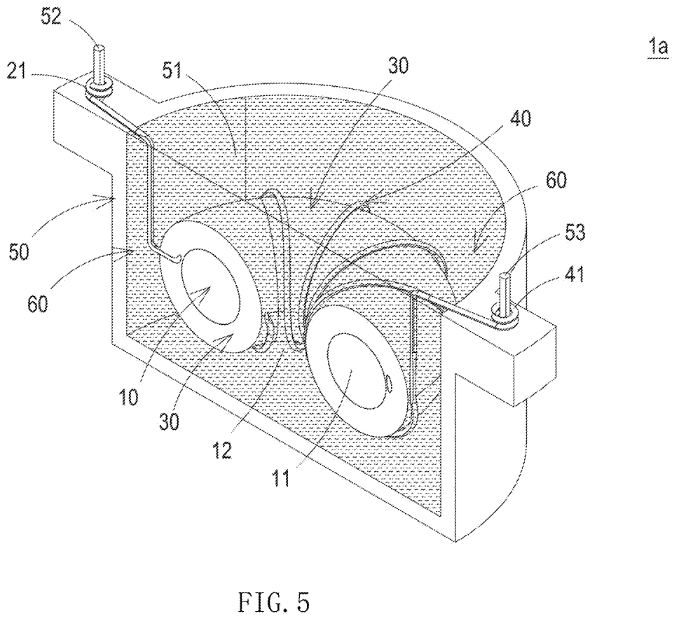

FIGS. 4A-4D are views showing structure of the transformer in a second embodiment of the invention in stages of manufacture. FIG. 5 is a cross-sectional view showing structure of the transformer in the second embodiment of the invention. The structure of the transformer la in this embodiment is similar to the transformer 1 shown in FIGS. 1 to 3A-3E, so that same reference signs are used to represent the same components, structures and functions, details of which are not redundantly described here.

Referring to FIGS. 2, 4A-4D, and 5, in this embodiment, the shell 50 comprises at least two first guide pins 52 and at least two second guide pins 53, which are disposed on an upper edge of the shell 50 opposite to one another, and exposed outside the accommodating space 51. However, the invention is not limited thereto. The at least two first leads 21 of the at least one first winding 20 can be connected to the at least two first guide pins 52, and the at least two second leads 41 of the at least one second winding 40 can be connected to the at least two second guide pins 53, respectively, whereas the invention is not limited to such connection manner of the at least two first leads 21 and the at least two second leads 41.

It shall be noted that in the step S2, the at least one first winding 20 is wound around the body part 11 of the magnetic core 10 through the hollow part 12 of the magnetic core 10, as shown in FIG. 4A. Then, in the step S3, the first infiltration material member 30 encloses the body part 11 of the magnetic core 10 and the at least one first winding 20, keeping the at least two first leads 21 being exposed outside, as shown in FIG. 4B. Then, in the step S4, the at least one second winding 40 is wound around the first infiltration material member 30 through the hollow part 12 of the magnetic core 10, and isolated from the at least one first winding 20. The at least two first leads 21 are exposed outside, as shown in FIG. 4C.

Then, in the step S5, the shell 50 is provided to accommodate the magnetic core 10, the at least one first winding 20, the first infiltration material member 30 and the at least one second winding 40 in the accommodating space 51 of the shell 50. The at least two first leads 21 are connected to the at least two first guide pins 52, and the at least two second leads 41 are connected to the at least two second guide pins 53 of the shell 50, respectively, with the at least two first leads 21 and the at least two second leads 41 being partially exposed outside the shell 50.

Finally, in step S6, the pouring sealant 60 is poured into the accommodating space 51, covering the magnetic core 10, the at least one first winding 20, the first infiltration material member 30, and the at least one second winding 40, and maintaining the at least two first leads 21 and the at least two second leads 41 being partially exposed outside the shell 50, as shown in FIG. 4D. The obtained transformer la is also shown in FIG. 5.

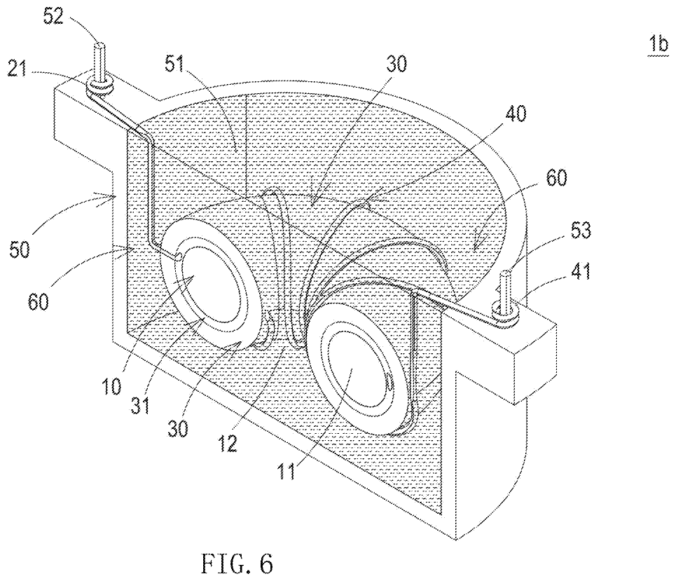

FIG. 6 is a cross-sectional view showing structure of the transformer lb in a third embodiment of the invention. In this embodiment, structure of the transformer lb is similar to the transformer la shown in FIGS. 4A-4D and 5, so that same reference signs are used to represent same components, structures, and functions, details of which are not redundantly described here.

Referring to FIGS. 2 and 6, the transformer lb in this embodiment differs from the transformer la shown in FIGS. 4A-4D and 5 in that it further comprises a second infiltration material member 31. Before the step S2, the second infiltration material layer 31 in advance encloses the body part 11 of the magnetic core 10 through the hollow part 12 of the magnetic core 10. Then, in the step S2, the at least one first winding 20 is wound around the second infiltration material member 31. Then, in the step S3, the first infiltration material member 30 encloses the body part 11 of the magnetic core 10, the second infiltration material member 31, and the at least one first winding 20 through the hollow part 12 of the magnetic core 10.

Then, under the condition of a negative pressure for example, the pouring sealant 60, such as the epoxy resin, is poured into the accommodating space 51 of the shell 50. The pouring sealant 60 fully enters into inside of the first infiltration material member 30 and the second infiltration material member 31, filling up the first infiltration material member 30 and the second infiltration material member 31, forming respective insulating isolation structures after being cured, so as to isolate the at least one first winding 20 from the at least one second winding 40 and from the magnetic core 10, respectively. The pouring process under the negative pressure ensures that no bubble exists inside the insulating structures and the pouring sealant 60, so that the withstand voltage and the partial discharge extinction voltage of the transformer lb can be significantly improved, the volume of the transformer lb can be reduced, and the cost can be decreased. In this embodiment, the second infiltration material member 31 is formed of glass fiber, non-woven fabric, or paper, although the invention is not limited thereto. The next steps S4 to S6 are same as that in the above described embodiment, the details of which are not redundantly described.

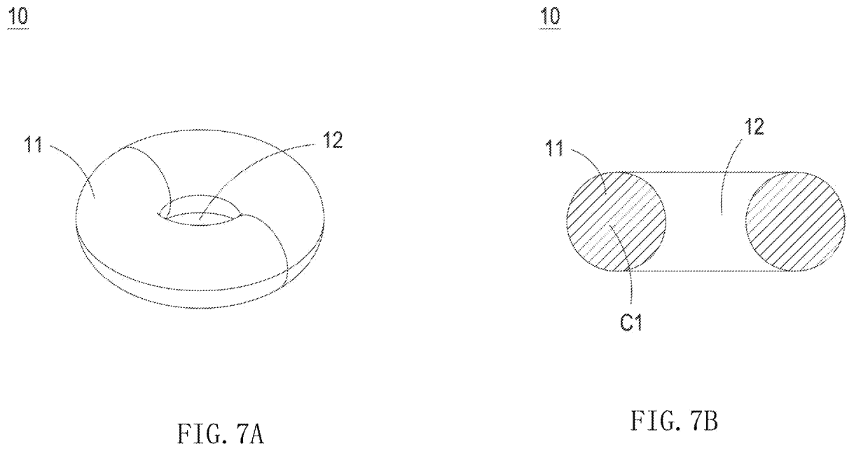

On the other hand, the magnetic core 10 in the above embodiment may be for example a ring. FIG. 7A shows a first example of a magnetic core in the transformer according to the invention. FIG. 7B is a cross-sectional view of FIG. 7A. In this embodiment, the magnetic core 10 is a ring, comprising the body part 11 and the hollow part 12 and having a circular cross section C1, which can improve electric field distribution of the at least one first winding 20 and the at least one second winding 40, improve partial discharge and withstand voltage levels, and further reduce the volume of the transformer. In other embodiment, the magnetic core 10 is a racetrack shape having a circular cross section.

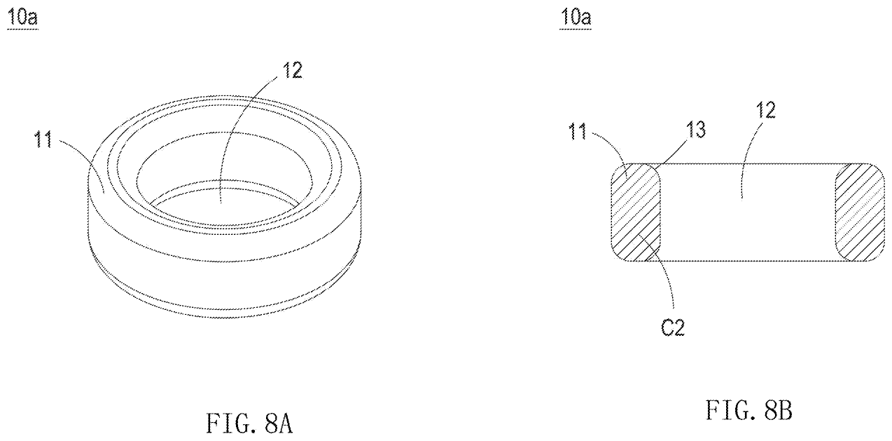

FIG. 8A shows a second example of the magnetic core in the transformer according to the invention. FIG. 8B is a cross-sectional view of FIG. 8A. In this embodiment, the magnetic core 10a is a ring, comprising the body part 11 and the hollow part 12, and having a rectangular cross section C2. The rectangular cross section C2 further comprises at least one chamfer part 13. For example, four right-angled corners of the rectangular cross section C2 are provided with the chamfer parts 13, respectively. In other embodiment, the magnetic core 10a may be a racetrack shape having the rectangular cross section C2 having also at least one chamfer part 13. In this embodiment, the arrangement of the chamfer part 13 can improve electric field distribution on surfaces of the high and low voltage windings formed by the at least one first winding 20 and the at least one second winding 40, reduce the maximum field intensity on the surfaces of the windings, improve the withstand voltage and the partial discharge extinction voltage of the transformer, reduce the volume of the transformer, and decrease the cost, although the invention is not limited thereto.

In addition, it shall be noted that the transformer 1 of the invention is not limited to the winding manner of the at least one first winding 20 and the at least one second winding 40. In this embodiment, both the at least one first winding 20 and the at least one second winding 40 are for example in a sparse winding manner through the hollow part 12 of the magnetic core 10. In this embodiment, both the at least one first winding 20 and the at least one second winding 40 are for example in a parallel winding manner through the hollow part 12 of the magnetic core 10. In other embodiment, both the at least one first winding 20 and the at least one second winding 40 may also be for example in a close winding manner through the hollow part 12 of the magnetic core 10. In other embodiment, one of the at least one first winding 20 and the at least one second winding 40 is in a sparse winding manner, and the other one is in a close winding manner, both through the hollow part 12 of the magnetic core 10. However, the invention is not limited thereto.

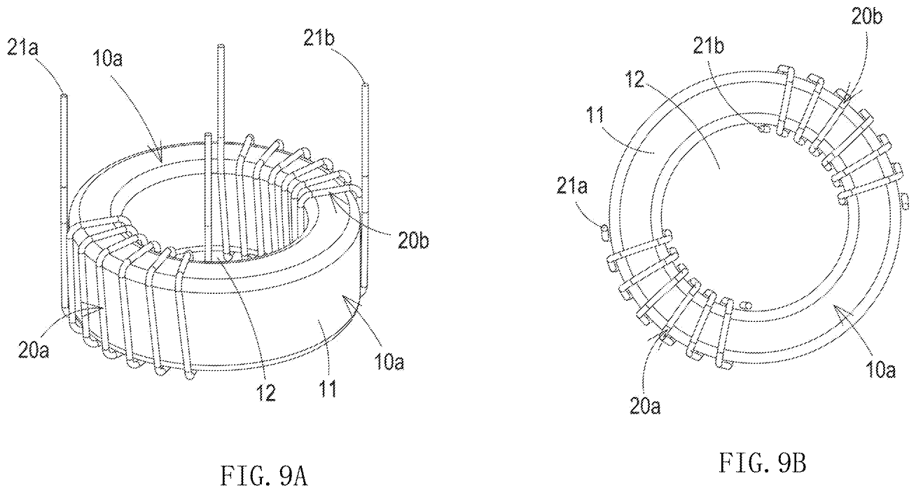

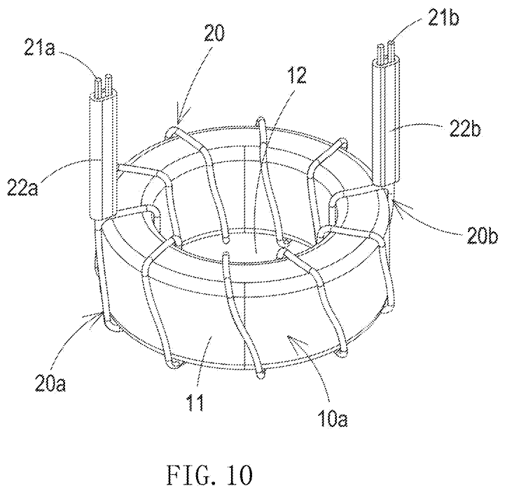

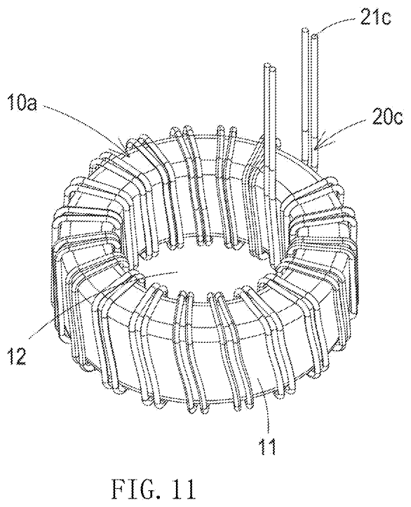

FIG. 9A shows a first example of the first winding wound around the magnetic core in the transformer according to the invention. FIG. 9B is a top view of FIG. 9A. In this embodiment, the at least one first winding 20 further comprises two first winding units 20a, 20b, which are separated from each other and wound around opposite sides of the magnetic core 10a, respectively. The two first leads 21a of first winding unit 20a are spatial opposite to the two first leads 21b of the first winding unit 20b. FIG. 10 shows a second example of the first winding wound around the magnetic core in the transformer according to the invention. In this embodiment, the at least one first winding 20 further comprises two first winding units 20a, 20b. A first sleeve 22a sheathing outside of the two first leads 21a of the first winding unit 20a is spatial opposite to a first sleeve 22b sheathing outside of the two first leads 21b of the first winding unit 20b. In other embodiment, either one of the at least one first winding 20 and the at least one second winding 40 may comprise a plurality of winding units, respectively, although the invention is not limited thereto. FIG. 11 shows a third example of the first winding wound around the magnetic core in the transformer according to the invention. In this embodiment, the at least one first winding 20c comprises two winding units wound around two first windings 20c of the body part 11, respectively, in a parallel winding manner, through the hollow part 12 of the magnetic core 10. In other embodiment, both the at least one first winding 20 and the at least one second winding 40 may comprise a plurality of winding units wound around the body part 11 of the magnetic core 10 in a parallel winding manner. However, the invention is not limited thereto, and the detailed are not described.

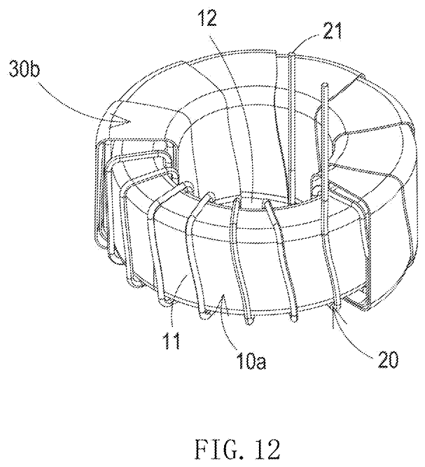

FIG. 12 is a schematic view showing the arrangement of the infiltration material member in the transformer according to the invention. Similar to the above-described embodiments, in this embodiment, the first infiltration material member 30b may be formed of, for example, strip-shaped glass fibers, non-woven fabric, or paper, wound around the body part 11 and the at least one first winding 20 through the hollow part 12 of the magnetic core 10a, with the at least two first leads 21 being exposed. Then, under a negative pressure condition, for example, a pouring sealant 60, such as, the epoxy resin is poured to the first infiltration material member 30b, to form an insulating isolation structure by curing. It shall be emphasized that only if the pouring sealant 60 is poured under the negative pressure to the first infiltration material member 30b, clearances inside the first infiltration material member 30b can be filled up, which ensures no defect such as crack and/or bubble existing inside the insulating isolation structure, so that the transformer structure 1 of the invention is facilitated to improve withstand voltage and partial discharge levels thereof, reduce the volume, enhance the competitiveness of the product, and also achieve the objects of simplifying manufacturing process and decreasing production cost.

In conclusion, the embodiments of the invention provide a transformer and a method for manufacturing the same. By providing the infiltration material member(s) between the windings, the withstand voltage and the partial discharge levels are improved, thereby reducing the volume, enhancing competitiveness of the product, while achieving the objects of simplifying manufacturing process and decreasing production cost. Moreover, the transformer of the invention includes the first winding, the magnetic core, the infiltration material member, the second winding, the pouring sealant, and the shell. Although voltage stress is concentrated between the first and second windings serving respectively as high and low voltage windings of the transformer, a reliable isolation structure is realized by providing the infiltration material member, so that high insulating property and miniaturization of the transformer can be achieved. The infiltration material member can form an insulating isolation structure after being poured with the pouring sealant, for example, in a negative pressure, and then cured. Due to the small flow resistance during the pouring in the negative pressure, bubbles inside the insulating isolation structure can easily flow out, which further ensures no defect such as crack and/or bubble inside the transformer. Thereby, the windings-isolation manner used in the transformer of the invention can significantly improve the withstand voltage and the partial discharge extinction voltage of the transformer, reduce the volume of the transformer, and decrease the cost.

Although several preferred embodiments of the present invention have been described, the present invention may be used with other configurations. It will be appreciated by those skilled in the art that, the present invention could have many other embodiments, and changes and modifications may be made thereto without departing from the invention in its broader aspects and as set forth in the following claims and equivalents thereof.

What is claimed is:

1. A transformer comprising:
a magnetic core having a body part and a hollow part passing through the body part;
at least one first winding wound around the body part of the magnetic core through the hollow part, wherein the at least one first winding comprises at least two first leads;
a first infiltration material member enclosing the body part of the magnetic core and the at least one first winding through the hollow part, with the at least two first leads of the at least one first winding being exposed;
at least one second winding wound around the first infiltration material member through the hollow part and isolated from the at least one first winding, wherein the at least one second winding comprises at least two second leads;
a shell comprising an accommodating space, in which the magnetic core, the at least one first winding, the first infiltration material layer, and the at least one second winding are accommodated, with the at least two first leads and the at least two second leads being partially exposed outside the shell; and
a pouring sealant poured into the accommodating space, covering the magnetic core, the at least one first winding, the first infiltration material member, and the at least one second winding, and maintaining the at least two first leads and the at least two second leads being partially exposed outside the shell.

2. The transformer according to claim 1, wherein the body part is of a ring or racetrack shape and has a rectangular cross section with at least one chamfer part.

3. The transformer according to claim 1, wherein the body part is of a ring or racetrack shape and has a circular cross section.

4. The transformer according to claim 1, further comprising a second infiltration material member enclosing the body part of the magnetic core through the hollow part, and separating the at least one first winding from the magnetic core.

5. The transformer according to claim 4, wherein the first infiltration material member is formed of glass fiber, non-woven fabric, or paper; and wherein the second infiltration material member is formed of glass fiber, non-woven fabric or paper; and wherein the pouring sealant is formed of epoxy resin.

6. The transformer according to claim 1, wherein both the at least one first winding and the at least one second winding are configured in a sparse winding distribution through the hollow part.

7. The transformer according to claim 1, wherein one of the at least one first winding and the at least one second winding is configured in a close winding distribution, while the other of the at least one first winding and the at least one second winding is configured in a sparse winding distribution through the hollow part; or the at least one first winding and the at least one second winding are both configured in a close winding distribution through the hollow part.

8. The transformer according to claim 1, wherein at least one of the at least one first winding and the at least one second winding is configured in a parallel winding distribution through the hollow part.

9. The transformer according to claim 1, wherein each of the at least one first winding and the at least one second winding comprises at least two winding units.

10. The transformer according to claim 1, further comprising a first sleeve sheathed onto the at least two first leads and a second sleeve sheathed onto the at least two second leads.

11. The transformer according to claim 1, wherein the shell comprises at least two first guide pins and at least two second guide pins, which are disposed on an upper edge of the shell and exposed outside the accommodating space, and wherein ends of the at least two first leads are connected to the at least two first guide pins, respectively, while ends of the at least two second leads are connected to the at least two second guide pins, respectively.

12. A method for manufacturing a transformer, comprising steps of:
(a) providing a magnetic core having a body part and a hollow part passing through the body part;
(b) winding at least one first winding around the body part of the magnetic core through the hollow part, wherein the at least one first winding comprises at least two first leads;
(c) enclosing the body part of the magnetic core and the at least one first winding with a first infiltration material member through the hollow part, with the at least two first leads of the at least one first winding being exposed;
(d) winding at least one second winding around the first infiltration material member through the hollow part and isolating the at least one second winding from the at least one first winding, wherein the at least one second winding comprises at least two second leads;
(e) providing a shell comprising an accommodating space, in which the magnetic core, the at least one first winding, the first infiltration material member, and the at least one second winding are accommodated, with the at least two first leads and the at least two second leads being partially exposed outside the shell; and
(f) pouring a pouring sealant into the accommodating space to cover the magnetic core, the at least one first winding, the first infiltration material member, and the at least one second winding and maintain the at least two first leads and the at least two second leads being partially exposed outside the shell.

13. The method for manufacturing a transformer according to claim 12, wherein the step (a) further comprises the step of:
(a1) enclosing the body part of the magnetic core with a second infiltration material member through the hollow part.

14. The method for manufacturing a transformer according to claim 13, wherein the first infiltration material member is formed of glass fiber, non-woven fabric, or paper; and wherein the second infiltration material member is formed of glass fiber, non-woven fabric, or paper; and wherein the pouring sealant is formed of epoxy resin.

15. The method for manufacturing a transformer according to claim 12, wherein the step (f) is to pouring the pouring sealant in a negative pressure.

16. The method for manufacturing a transformer according to claim 12, wherein the body part is of a ring or racetrack shape and has a rectangular cross section with at least one chamfer part.

17. The method for manufacturing a transformer according to claim 12, wherein the body part is of a ring or racetrack shape and has a circular cross section.

18. The method for manufacturing a transformer according to claim 12, wherein both the at least one first winding and the at least one second winding are configured in a sparse winding distribution through the hollow part.

19. The method for manufacturing a transformer according to claim 12, wherein one of the at least one first winding and the at least one second winding is configured in a close winding distribution, while the other of the at least one first winding and the at least one second winding is configured in a sparse winding distribution through the hollow part; or the at least one first winding and the at least one second winding are both configured in a close winding distribution through the hollow part.

20. The method for manufacturing a transformer according to claim 12, wherein at least one of the at least one first winding and the at least one second winding is configured in a parallel winding distribution through the hollow part.
